(19) United States
(12) Patent Application Publication
(10) Pub. No.: US 2026/0158755 A1
(43) Pub. Date: Jun. 11, 2026

(54) GLASS COVER MANUFACTURING USING A SINGLE-CRYSTAL SILICON MOLD

(71) Applicant: Murata Manufacturing Co., Ltd., Nagaokakyo-shi (JP)

(72) Inventors: Jaakko RUOHIO, Helsinki (FI); Anssi BLOMQVIST, Helsinki (FI); Mikael KAUTTO, Helsinki (FI)

(21) Appl. No.: 19/049,953

(22) Filed: Feb. 10, 2025

(30) Foreign Application Priority Data
Feb. 16, 2024 (EP) 24158101.6

(51) Int. Cl. B29D 11/00; C03B 23/035

(52) U.S. Cl. CPC B29D 11/00307; C03B 23/0357

(57) ABSTRACT

The disclosure relates to methods of manufacturing a plurality of devices having an optical glass cover comprising an angled optical window. An off-axis cut silicon wafer is used as a mold for molding borosilicate glass to form a plurality of angled glass portions. The polished borosilicate glass is anodically bonded to a silicon device wafer comprising a plurality of structures or circuitry for the plurality of devices. After removing the silicon mold by etching, the silicon wafer stack is diced to separate the plurality of devices, each having the optical glass cover comprising a respective angled optical window determined by one of the angled recesses of the silicon mold.

### CROSS REFERENCE TO RELATED APPLICATIONS

This application claims priority to European Patent Application No. 24158101.6, filed Feb. 16, 2024, the contents of which is hereby incorporated by reference in its entirety.

### TECHNICAL FIELD

The present disclosure relates to a method of manufacturing a transparent cover, and particularly to a method of manufacturing a transparent glass cover with angled optical window suitable to be used to protect a MEMS device such as a MEMS mirror.

### BACKGROUND

One possible method of producing an image in augmented reality (AR) glasses, virtual reality (VR) glasses and heads-up displays is by scanning a light beam utilizing a tilting mirror system. A very small tilting mirror for such purpose may be manufactured using microelectromechanical system (MEMS) technology.

Packaging the mirror system into a hermetic enclosure enables low-loss operation of the tilting mirror, in other words, a high-quality factor. For example, gases may be reduced or removed from the hermetic enclosure would cause mechanical losses for the fast-moving mirror.

A package of a MEMS mirror should preferably comprise a transparent cover. When using a dual axis tilting mirror, reflection of the light beam from the interface or interfaces of the transparent cover and the ambient and/or hermetic atmosphere results in a bright spot. When using two single axis tilting mirror, and reflection of the light beam from the interface or interfaces of the transparent cover and the ambient and/or hermetic atmosphere results in a bright line. Utilizing an angled cover in the hermetic package is a known solution to prevent such bright line or spot coinciding within the intended image area.

U.S. Pat. No. 8,517,545, for example, discloses a cover for microsystems and method for producing a cover, in which an angled optical window, mirror or partially reflecting mirror made of glass is used to avoid bright spots. Silicon is used as reinforcing elements in the regions of the glass wafer that function as angled optical windows, while glass sheet is deformed so that reinforced portions are inclined. However, such reinforcing elements are difficult to manufacture and add cost, and controlling the inclination is difficult.

Silicon wafers are grown starting from a crystal seed having a regular crystal structure, with silicon having a diamond cubic structure with a constant lattice spacing. When silicon is cut into wafers, the surface of the wafer is aligned in one of several directions with respect to the crystal structure, known as crystal orientations. This crystal orientation is defined by a Miller index. Most common Miller indexes for silicon wafers are <100> and <111>, but also <110> is occasionally used. In each of these cases, the silicon is cut in a crystal orientation. However, silicon wafers may also be cut in an off-crystal orientation. Surfaces of these different crystal orientations may alternatively be referred to with notations Si(100), Si(110), and Si(111). Crystal orientation is important since many of a single crystal's structural and electronic properties are highly anisotropic. Ion implantation depths depend on the wafer's crystal orientation since each direction offers distinct paths for transport.

A problem is to enable manufacturing of at least one angled optical window in an optical glass cover in simple and cost-effective manufacturing process, while ensuring high quality of the at least one angled optical window in the optical glass cover.

### SUMMARY OF THE INVENTION

An object of the present disclosure is to provide a manufacturing method (and an optical glass cover with at least one angled optical window) so as to solve the above problem.

The disclosure is based on the idea of using a single-crystal silicon mold for shaping an optical glass cover with one or more angled optical windows.

In some aspects, the techniques described herein relate to a method of manufacturing a plurality of devices having an optical glass cover including an angled optical window. In this aspect, the method includes patterning a face of an off-axis cut silicon wafer to determine a plurality of unmasked areas of the off-axis cut silicon wafer, wet-etching the plurality of unmasked areas to reveal respective a plurality of Si surfaces of the off-axis cut silicon wafer, to form a silicon mold including a plurality of angled recesses, wherein an angled shape of each angled recess is determined by a Si surface, molding heat-softened borosilicate glass using the silicon mold to form a plurality of angled glass portions, cooling the molded borosilicate glass, optionally grinding the molded borosilicate glass, polishing the cooled and optionally grinded borosilicate glass, anodically bonding the polished borosilicate glass to a silicon device wafer including a plurality of structures or circuitry for the plurality of devices, and dicing a wafer stack to separate the plurality of devices having the optical glass cover, wherein the optical glass cover of each device includes the respective angled optical window determined by one of the angled recesses of the silicon mold, after anodically bonding and before dicing the wafer stack, the method further includes: removing the silicon mold by etching to release the wafer stack with the borosilicate glass and the silicon device.

In some aspects, the techniques described herein relate to a method 1, wherein quality of the plurality of Si surfaces revealed by the wet-etching is further improved by hydrogen (H2) or acid treatment.

In some aspects, the techniques described herein relate to a method 1, wherein the silicon mold is removed by ethylene diamine pyrocatechol (EDP) etching or by reactive-ion etching (RIE).

In some aspects, the techniques described herein relate to a method, wherein molding borosilicate glass using the silicon mold further includes: applying a sheet of borosilicate glass on the silicon mold in vacuum to hermetically seal the plurality of angled recesses in the silicon mold, and a) heating up the sheet of borosilicate glass, and applying an inert pressure to cause the heated sheet of borosilicate glass to adapt to the shape of the silicon mold, or b) heating up the sheet of borosilicate glass into a temperature above its Littleton Softening Point and allowing the heated sheet of borosilicate glass to adapt to the shape of the silicon mold under its own weight.

In some aspects, the techniques described herein relate to a method, wherein thickness of the sheet or layer of borosilicate glass is less than a greatest vertical distance from non-etched portions of the patterned face of the silicon mold to a bottom of the recess formed by the angled portion of the silicon mold.

In some aspects, the techniques described herein relate to a method, wherein thickness of the sheet or the layer of borosilicate glass is between 50 μm and 500 μm.

In some aspects, the techniques described herein relate to a method, wherein molding borosilicate glass using the silicon mold includes: molding a layer of heat-softened borosilicate glass on the silicon mold, and grinding the molded layer of borosilicate glass after cooling and before polishing.

In some aspects, the techniques described herein relate to a method, wherein thickness of the layer of borosilicate glass is more than a greatest vertical distance from non-etched portions of the patterned face of the silicon mold to the bottom of the recess formed by the angled portion of the silicon mold.

In some aspects, the techniques described herein relate to a method, wherein thickness of the layer of borosilicate glass is between 200 μm and 1000 μm.

In some aspects, the techniques described herein relate to a method, wherein a cut angle (α) of the off-axis cut silicon wafer is in a range from 5° to 25°, preferably about 20° off with respect to a Si crystal orientation, and a tilt angle (β) of the angled optical window is equal to the cut angle (α) of the off-axis cut silicon wafer.

In some aspects, the techniques described herein relate to a method, wherein the plurality of structures or devices include a plurality of MEMS devices.

In some aspects, the techniques described herein relate to a method, wherein the plurality of structures or devices include a plurality of MEMS mirrors, and wherein the cut angle (α) of the off-axis cut silicon wafer is greater than maximum tilt angle (β) of the respective MEMS mirror.

In some aspects, the techniques described herein relate to a MEMS mirror manufactured using the method.

In some aspects, the techniques described herein relate to a pair 12.

In some aspects, the techniques described herein relate to a method of manufacturing a plurality of devices having an optical glass cover including an angled optical window, the method includes, in order of completion: patterning a face of an off-axis cut silicon wafer to determine a plurality of unmasked areas of the off-axis cut silicon wafer, wet-etching the plurality of unmasked areas to reveal respective a plurality of Si surfaces of the off-axis cut silicon wafer, to form a silicon mold including a plurality of angled recesses, wherein an angled shape of each angled recess is determined by a Si surface, molding heat-softened borosilicate glass using the silicon mold to form a plurality of angled glass portions, cooling the molded borosilicate glass, polishing the cooled, anodically bonding the polished borosilicate glass to a silicon device wafer including a plurality of structures or circuitry for the plurality of devices, and dicing a wafer stack to separate the plurality of devices having the optical glass cover, wherein the optical glass cover of each device includes the respective angled optical window determined by one of the angled recesses of the silicon mold, wherein thickness of a sheet or a layer of borosilicate glass is between 50 μm and 500 μm, wherein thickness of the layer of borosilicate glass is more than a greatest vertical distance from non-etched portions of the patterned face of the silicon mold to a bottom of the recess formed by the angled portion of the silicon mold.

In some aspects, the techniques described herein relate to a method, wherein molding borosilicate glass using the silicon mold further includes: applying the sheet of borosilicate glass on the silicon mold in vacuum to hermetically seal the plurality of angled recesses in the silicon mold, and a) heating up the sheet of borosilicate glass, and applying an inert pressure to cause the heated sheet of borosilicate glass to adapt to the shape of the silicon mold, or b) heating up the sheet of borosilicate glass into a temperature above its Littleton Softening Point and allowing the heated sheet of borosilicate glass to adapt to the shape of the silicon mold under its own weight.

In some aspects, the techniques described herein relate to a method, wherein thickness of the sheet or layer of borosilicate glass is less than a greatest vertical distance from non-etched portions of the patterned face of the silicon mold to a bottom of the recess formed by the angled portion of the silicon mold.

In some aspects, the techniques described herein relate to a method, wherein molding borosilicate glass using the silicon mold includes: molding a layer of heat-softened borosilicate glass on the silicon mold, and grinding the molded layer of borosilicate glass after cooling and before polishing.

In some aspects, the techniques described herein relate to a method of manufacturing a plurality of devices having an optical glass cover including an angled optical window. In this aspect, the method includes patterning a face of an off-axis cut silicon wafer to determine a plurality of unmasked areas of the off-axis cut silicon wafer, wet-etching the plurality of unmasked areas to reveal respective a plurality of Si surfaces of the off-axis cut silicon wafer, to form a silicon mold including a plurality of angled recesses, wherein an angled shape of each angled recess is determined by a Si surface, molding heat-softened borosilicate glass using the silicon mold to form a plurality of angled glass portions, cooling the molded borosilicate glass, polishing the cooled borosilicate glass, anodically bonding the polished borosilicate glass to a silicon device wafer including a plurality of structures or circuitry for the plurality of devices, and dicing a wafer stack to separate the plurality of devices having the optical glass cover, wherein the optical glass cover of each device includes the respective angled optical window determined by one of the angled recesses of the silicon mold, after anodically bonding and before dicing the wafer stack, the method further includes: removing the silicon mold by etching to release the wafer stack with the borosilicate glass and the silicon device, wherein molding borosilicate glass using the silicon mold further includes: molding a layer of heat-softened borosilicate glass on the silicon mold, and grinding the molded layer of borosilicate glass after cooling and before polishing, wherein thickness of the layer of borosilicate glass is between 200 μm and 1000 μm.

In some aspects, the techniques described herein relate to a method, wherein cooling of the molded borosilicate glass is performed using a controlled temperature ramp to ensure high quality of the borosilicate glass.

### BRIEF DESCRIPTION OF THE DRAWINGS

In the descriptions that follow, like parts are marked throughout the specification and drawings with the same numerals, respectively. The drawings are not necessarily drawn to scale and certain drawings may be illustrated in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings wherein:

FIG. 1 illustrates a silicon crystal and a Si(111) crystal orientation in accordance with aspects of the present disclosure;

FIG. 2 illustrates cutting of silicon wafers in an off-crystal orientation in accordance with aspects of the present disclosure;

FIGS. 3A to 3F illustrate manufacturing steps of an optical glass cover of a MEMS mirror in accordance with aspects of the present disclosure;

FIGS. 4A to 4G illustrate schematically manufacturing steps of a MEMS mirror device in accordance with aspects of the present disclosure; and

FIGS. 5A and 5B illustrate schematically MEMS mirror devices with angled optical glass covers in accordance with aspects of the present disclosure.

The figures are for illustrative purposes only and are not shown in scale.

### DETAILED DESCRIPTION

The present disclosure relates to a method of manufacturing a transparent cover, in particular a transparent glass cover with an angled optical window, and particularly to a method of manufacturing a transparent glass cover with angled optical window suitable to be used to protect a MEMS device such as a MEMS mirror. The present disclosure further concerns a MEMS mirror device with an angled optical window.

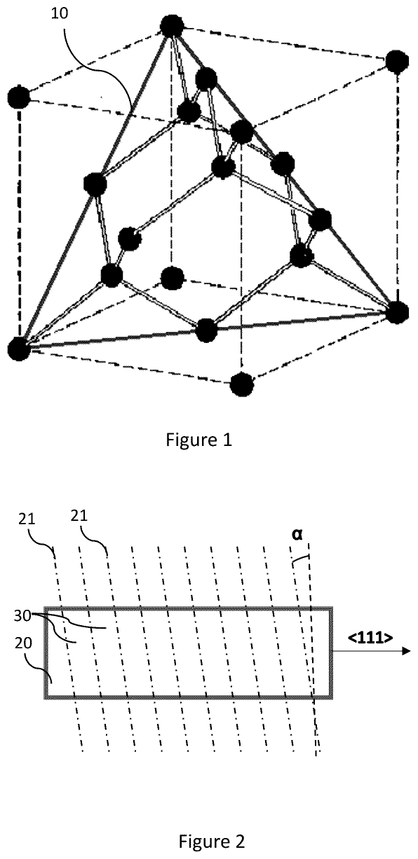

FIG. 1 illustrates a silicon crystal with a plurality of silicon atoms in a crystal lattice. Crystal orientation referred to as Si(111) is illustrated with the triangular shape marked with a bold line 10.

FIG. 2 illustrates generation of off-axis cut silicon wafers. High-purity silicon crystalline material may be formed using a so called Czochralski method, in which a cylindrical boule 20 is formed by pulling a seed crystal from a melt. The generated boule 20 shown in this side view, has a predetermined crystal orientation. The arrow <111> illustrates normal of the <111> orientation. For generating off-axis cut silicon wafers, boule 20 is cut into a plurality of off-axis cut silicon wafers 30 in a predetermined cut angle α0 with respect to the <111> orientation, as illustrated with the plurality of mutually parallel dashed lines 21. In the field of the disclosure, the optimal cut angle depends on optical requirements set by the device for which the optical window is manufactured. The cut angle is preferably bigger than the maximum tilting angle of the MEMS mirror. In this example, the cut angle α is within the range from 15° to 25°, preferably about 20°. For some applications, the cut angle α may be selected within a range from 5° to 25°. For the disclosed manufacturing method, the off-axis cut silicon wafer is preferably not doped.

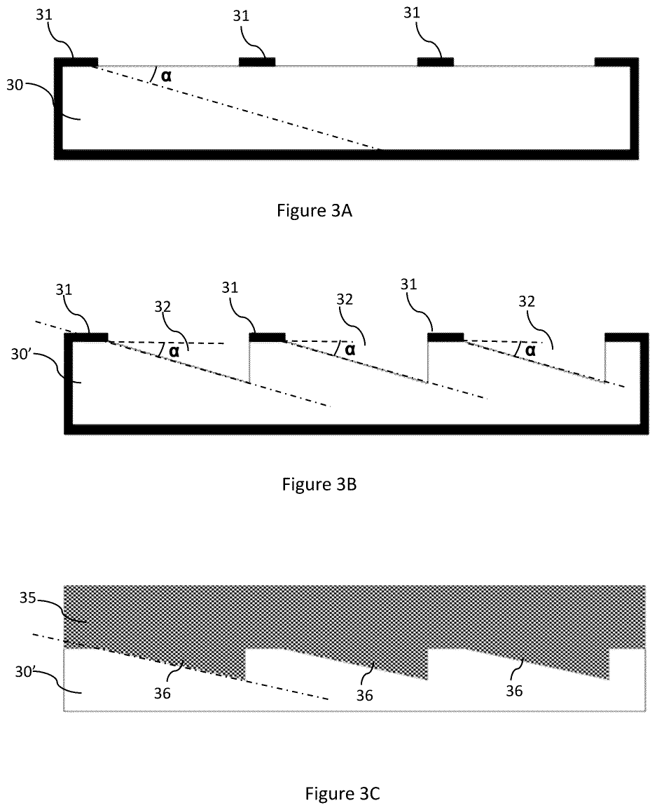

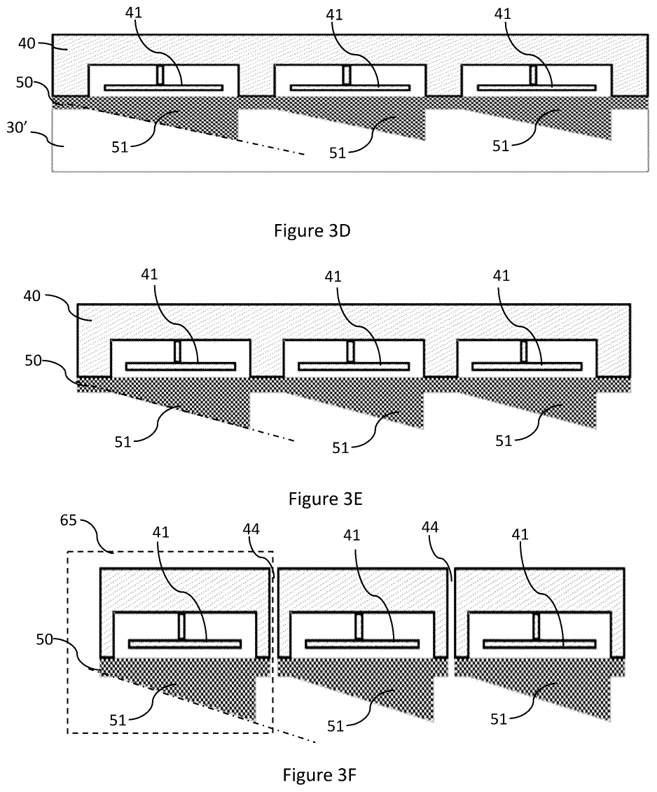

FIGS. 3A to 3F illustrate manufacturing steps of an optical glass cover of a MEMS mirror according to some aspects. The optical glass cover comprises an angled optical window.

FIG. 3A illustrates an off-axis cut silicon wafer 30, that is masked with a mask 31. The masking pattern comprises a plurality of unmasked areas, which leave desired portions of the off-axis cut silicon wafer 30 exposed. Any applicable masking method may be used. For example, a silicon nitride mask may be patterned using a photoresist mask and plasma etching.

As illustrated by the FIG. 3B, the masked off-axis cut silicon wafer 30 is wet-etched to reveal a plurality of Si(111) surfaces of the off-axis cut silicon wafer, to form a silicon mold 30′ comprising a plurality of angled recesses each determined a Si(111) surface. The cut angle α of the off-axis silicon wafer 30 is equal to the tilt angle α of the angled recesses in the silicon mold 30′. One suitable wet-etching method to be used for this step is potassium hydroxide (KOH) etching, which is well-known to etch silicon crystals anisotropically. An anisotropic etch means that etch rate is different for different Si crystal planes.

The quality of the plurality of Si(111) surfaces revealed by the wet-etching may further be improved by hydrogen (H2) and/or acid treatment.

After forming the silicon mold 30′ by etching, the mask 31 is removed. If the exemplary nitride mask is used, the mask 31 may be removed by etching. The result is a silicon mold 30′ with a plurality of angled recesses 32, each having the tilt angle α determined by the cut angle α of the off-axis cut silicon wafer.

FIG. 3C illustrates the next step, in which a layer of borosilicate glass 35 is molded. A layer of borosilicate glass 35 is applied on the silicon mold 30′ and softened by heating it so that the heated layer of borosilicate class 35 becomes molded by the silicon mold 30′, the borosilicate glass filling the angled recesses 32 forms a plurality of angled glass portions 36 in the molded layer of borosilicate glass 35. According to some aspects, the layer of borosilicate glass may be heated into a temperature at or above its Littleton Softening Point, which enables the heated layer of borosilicate glass to adapt to the shape of the silicon mold 30′ under its own weight. According to some aspects, inert pressure may be applied on the softened layer of borosilicate glass 35 such that it fills the angled recesses 32. In the latter alternative, it is not necessary to heat up the layer of borosilicate glass 35 to or above the Littleton Softening Point temperature, but it is enough that it is heated into a temperature that makes it moldable.

In this example, thickness of the layer of borosilicate glass 35 is more than the greatest depth of the angled recesses 32 in the silicon mold 30′, so that the patterned face of the silicon mold 30′ is fully covered by the layer of borosilicate glass 35.

After the molded layer of borosilicate glass has cooled and hardened, it is ground to remove excess thickness of the borosilicate glass layer, optionally further polished to generate and/or improve a flat outer face of the molded borosilicate glass layer. Preferably, cooling of the borosilicate glass is performed using a controlled temperature ramp to ensure high quality of the hardened, molded borosilicate glass layer. The borosilicate glass is now readily formed as the optical glass cover 50 that comprises a plurality of angled optical windows.

FIG. 3D illustrates the next step, in which the outer face of the borosilicate glass layer is anodically bonded to a MEMS wafer 40 comprising a plurality of MEMS mirrors 41. Details of manufacturing the MEMS wafer 40 are not in the scope of this disclosure. The optical glass cover 50 that comprises a plurality of angled optical windows 51 is protected by the silicon mold 30′ during the bonding step.

FIG. 3E illustrates the next step, in which the silicon mold 30′ is removed by etching. This etching may be performed for example by using ethylene diamine pyrocatechol (EDP) etching or by reactive-ion etching (RIE), which effectively removes the silicon, but do not harm the borosilicate glass. Optionally, a layer of suitable material, for example gold or chrome deposited on top of the silicon mold wafer improves selectivity and reduces potential damage. Optical glass cover 50 now forms a plurality of angled optical windows 51.

In accordance with one aspect of the disclosure, only the exposed face of the angled optical windows 51 is angled, while the non-exposed face of the optical glass cover 50 that is towards the plurality of MEMS mirrors 41 is not angled, but forms a flat plane.

FIG. 3F illustrates step of dicing 44 the MEMS wafer provided with the optical glass cover to separate the plurality of MEMS mirror devices 65. Each MEMS mirror device comprises a respective angled optical window formed in the borosilicate glass as determined by one of the angled recesses 32 of the silicon mold 30′.

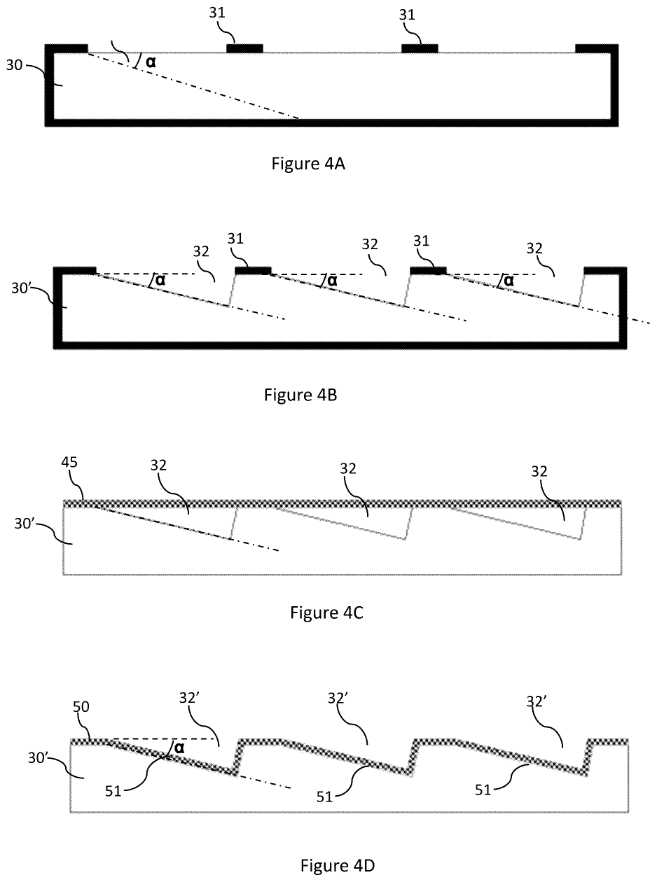

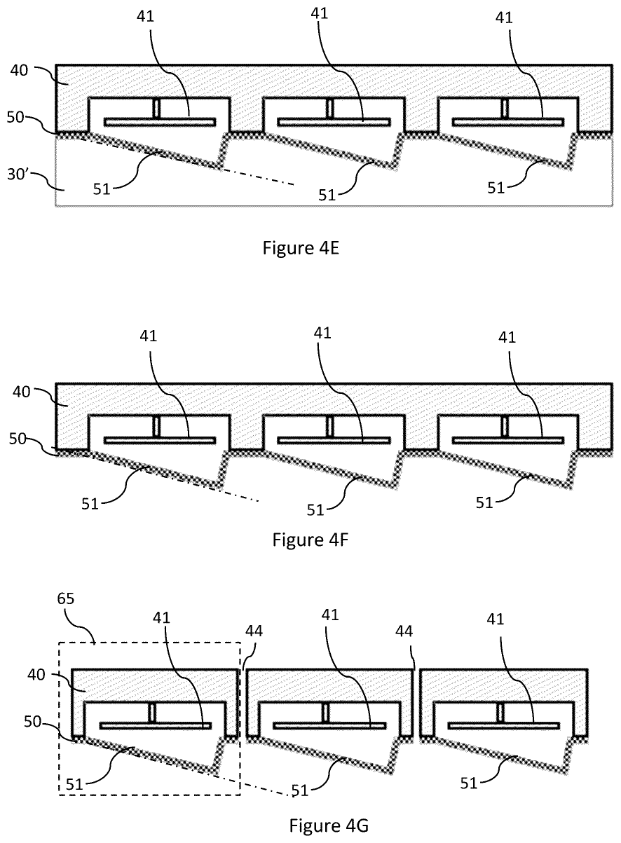

FIGS. 4A to 4G illustrate manufacturing steps of an optical glass cover of a MEMS mirror according to some aspects. The optical glass cover comprises an angled optical window.

FIG. 4A illustrates an off-axis cut silicon wafer 30, that is masked with a mask 31. The masking pattern comprises a plurality of unmasked areas, which leave desired portions of the off-axis cut silicon wafer 30 exposed. Any applicable masking method may be used. For example, a silicon nitride mask may be patterned using photoresist mask and etched with plasma.

As illustrated by the FIG. 4B, the masked off-axis cut silicon wafer 30 is wet-etched to reveal a plurality of Si(111) surfaces of the off-axis cut silicon wafer, to form a silicon mold 30′ comprising a plurality of angled recesses each determined a Si(111) surface. The cut angle α of the off-axis silicon wafer 30 is equal to the tilt angle α of the angled recesses in the silicon mold 30′. One suitable wet-etching method to be used for this step is potassium hydroxide (KOH) etching, which is well-known to etch silicon crystals anisotropically.

The quality of the plurality of Si(111) surfaces revealed by the wet-etching may further be improved by hydrogen (H2) and/or acid treatment.

After forming the silicon mold 30′ by etching, the mask 31 is removed. If the exemplary silicon nitride mask is used, the mask 31 may be removed by etching. The result is a silicon mold 30′ with a plurality of angled recesses 32 on one face of the silicon mold 30′, each angled recess 32 having the tilt angle α determined by the cut angle α of the off-axis cut silicon wafer.

Next, a sheet of borosilicate glass 45 is molded using the silicon mold 30′.

FIG. 4C illustrates a step in which the initially flat sheet of borosilicate glass 45 is first applied in vacuum on the patterned face of the silicon mold 30′ to hermetically seal the plurality of angled recesses 32 in the silicon mold 30′ with the sheet of borosilicate glass 45. The sheet of borosilicate glass is then heated in vacuum to soften it, so that it becomes moldable. These steps are performed in vacuum to ensure that no gas remains in the angled recesses 32 between the silicon mold 30′ and the sheet of borosilicate glass 45, which would reduce quality of the eventually molded borosilicate glass and thus quality the optical cover. As known in the art, heating temperature of borosilicate glass depends heavily on type of glass and exact process as well as desired viscosity of the glass.

After hermetically sealing the angled recesses 32 with the initially flat, heated sheet of borosilicate glass 45, inert pressure may be applied to cause the heated sheet of borosilicate glass 45 to adapt to the shape of the silicon mold 30′, thus pressing the initially flat sheet of borosilicate glass 45 into the angled recesses 32 of the silicon mold 30′ to shape the sheet of borosilicate glass 45 into the desired shape of the optical glass cover 50 now forming the plurality of angled optical windows 51. Alternatively, the sheet of borosilicate glass 45 may be heated into a temperature above its Littleton Softening Point, which enables the heated sheet of borosilicate glass 45 to adapt to the shape of the silicon mold 30′ under its own weight, so that application of inert pressure is not required. However, inert pressure may be applied even when the sheet of borosilicate glass is heated in a temperature at or above its Littleton Softening Point for speeding up the shape adaptation step.

The readily molded sheet of borosilicate glass is then cooled to harden it. Preferably, cooling of the borosilicate glass is performed using a controlled temperature ramp to ensure high quality of the hardened glass. After the molded sheet of borosilicate glass has cooled and hardened, it is optionally polished to further improve quality of the angled optical windows 51.

To achieve the desired shape with good quality, thickness of the sheet of borosilicate glass 45 should be less than the greatest depth of the angled recesses 32 in the silicon mold 30′, so that upper face of the optical glass cover 50 formed by the molded sheet of borosilicate glass 45 comprises angled recesses 32′ in the upper face angled optical windows 51.

According to an exemplary manufacturing process, maximum depth of the angled recesses 32 measured from the outer surface of the patterned face of the silicon mold 30′ depends on dimensions of the patterned areas on the silicon mold 30′ and the cut angle α. For example a recess 32 generated into the silicon mold 30′ with a α=15° and a 0.5 mm wide opening in the mask 31 is tan(15°)*0.5 mm=0.13 mm and a recess 32 generated into a silicon mold 30′ with a α=25° and a 5 mm wide opening in the mask 31 is tan(25°)*15mm=2.3 mm. Thickness of the sheet of borosilicate glass 45 is between 50 μm and 500 μm, preferably between 100 μm and 400 μm, more preferably between 150 μm and 300 μm, most preferably about 200 μm.

FIG. 4E illustrates the next step, in which the optionally polished borosilicate glass layer is anodically bonded to a MEMS wafer 40 comprising a plurality of MEMS mirrors 41. Details of manufacturing the MEMS wafer 40 are not in the scope of this disclosure.

FIG. 4F illustrates the next step, in which the silicon mold 30′is removed by etching. This etching may be performed for example using ethylene diamine pyrocatechol (EDP) etching or by reactive-ion etching (RIE), which effectively removes the silicon, but does not harm the borosilicate glass.

FIG. 4G illustrates step of dicing 44 the MEMS wafer provided with the optical glass cover to separate the plurality of MEMS mirror devices 65. Each MEMS mirror device 65 comprises a respective angled optical window formed in the borosilicate glass as determined by one of the angled recesses 32 of the silicon mold 30′.

As known in the art, diced MEMS mirror devices 65 received as results of step 3F or 4G are typically further provided with external electrical connections. However, details of implementing such additional features of the MEMS or other applicable devices are not in scope of this disclosure.

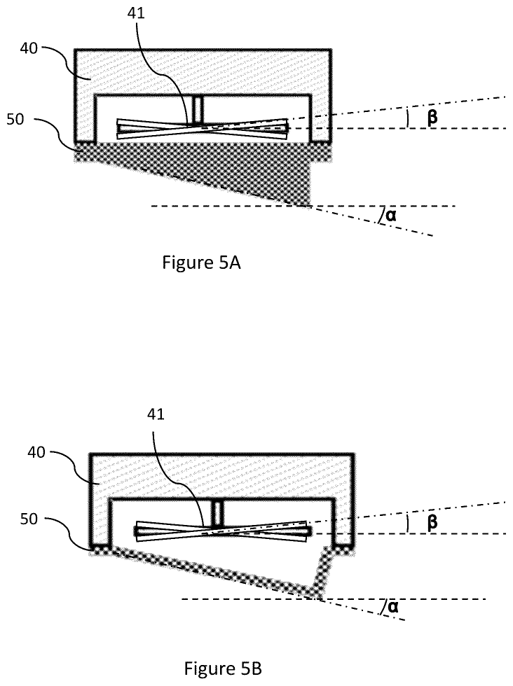

FIG. 5A illustrates a single MEMS mirror device 65 implemented with the optical glass cover comprising an angled optical window according to one aspect of the disclosure. FIG. 5B illustrates a single MEMS mirror device 65 implemented with the optical glass cover comprising an angled optical window according to one aspect of the disclosure. Tilt angle α of the angled optical window and thus also the cut angle of the off-axis cut silicon wafer should be more than the maximum tilt angle β of the MEMS mirror to avoid bright spots being generated due to the angled optical window, which could occur if the angled optical window and the MEMS mirror were parallel at any applied tilting angle of the MEMS mirror.

Depending on the manufacturer's process technologies, the manufacturing process of the first aspect is likely easier to implement than manufacturing process of the second aspect. A possible technical drawback of the first aspects is that the inner surface of the angled optical window is not angled, which may cause a lower intensity bright spot in the field of view. The second aspect has all surfaces of the angled optical window angled, thus provides a higher quality solution but may be more difficult and expensive to manufacture. The thinner angled optical window according to the second aspect may be less tolerant to mechanical impacts than the thicker optical window according to the first aspect. Selection of preferred aspects thus depends at least on requirements of optical quality and robustness of the device.

Although the disclosure has been explained using a MEMS mirror device as a non-limiting example, the disclosure is not limited to MEMS mirror devices, but is applicable to any type of silicon-based devices comprising circuitry and/or structures that are manufactured by processing a silicon wafer and need an angled optical window for covering the silicon device and protecting at least some parts of the silicon device from ambient environment with an angled optical window.

In general, the description of the aspects disclosed should be considered as being illustrative in all respects and not being restrictive. The scope of the present disclosure is shown by the claims rather than by the above description and is intended to include meanings equivalent to the claims and all changes in the scope. While exemplary aspects of the invention have been described above, it is to be understood that variations and modifications will be apparent to those skilled in the art without departing from the scope and spirit of the invention.

What is claimed:

1. A method of manufacturing a plurality of devices having an optical glass cover comprising an angled optical window, the method comprises:
patterning a face of an off-axis cut silicon wafer to determine a plurality of unmasked areas of the off-axis cut silicon wafer;
wet-etching the plurality of unmasked areas to reveal a plurality of Si surfaces of the off-axis cut silicon wafer, to form a silicon mold comprising a plurality of angled recesses, wherein an angled shape of each angled recess is determined by a respective Si surface;
molding heat-softened borosilicate glass using the silicon mold to form a plurality of angled glass portions;
cooling the molded borosilicate glass;
polishing the cooled borosilicate glass;
anodically bonding the polished borosilicate glass to a silicon device wafer comprising a plurality of structures or circuitry for the plurality of devices;
removing the silicon mold by etching to release a wafer stack with the borosilicate glass and the silicon device wafer; and
dicing the wafer stack to separate the plurality of devices having the optical glass cover,
wherein the optical glass cover of each device comprises the respective angled optical window determined by one of the angled recesses of the silicon mold.

2. The method of manufacturing according to claim 1, further comprising improving a quality of the plurality of Si surfaces by hydrogen (H2) or acid treatment.

3. The method of manufacturing according to claim 1, further comprising removing the silicon mold by ethylene diamine pyrocatechol (EDP) etching or by reactive-ion etching (RIE).

4. The method according to claim 1, wherein molding the borosilicate glass using the silicon mold further comprises:
applying a sheet of borosilicate glass on the silicon mold in vacuum to hermetically seal the plurality of angled recesses in the silicon mold, and
a) heating up the sheet of borosilicate glass, and applying an inert pressure to cause the heated sheet of borosilicate glass to adapt to the shape of the silicon mold, or
b) heating up the sheet of borosilicate glass into a temperature above its Littleton Softening Point and allowing the heated sheet of borosilicate glass to adapt to the shape of the silicon mold under its own weight.

5. The method according to claim 4, wherein a thickness of the sheet of borosilicate glass is less than a greatest vertical distance from non-etched portions of the patterned face of the silicon mold to a bottom of the recess formed by the angled portion of the silicon mold.

6. The method according to claim 5, wherein the thickness of the sheet of borosilicate glass is between 50 μm and 500 μm.

7. The method according to claim 1, wherein molding the borosilicate glass using the silicon mold comprises:
molding a layer of heat-softened borosilicate glass on the silicon mold, and
grinding the molded layer of borosilicate glass after cooling and before polishing.

8. The method according to claim 6, wherein a thickness of a layer of borosilicate glass is more than a greatest vertical distance from non-etched portions of the patterned face of the silicon mold to the bottom of the recess formed by the angled portion of the silicon mold.

9. The method according to claim 7, wherein a thickness of the layer of borosilicate glass is between 200 μm and 1000 μm.

10. The method according to claim 1, wherein a cut angle (α) of the off-axis cut silicon wafer is in a range from 5° to 25° with respect to a Si crystal orientation, and a tilt angle (β) of the angled optical window is equal to the cut angle (α) of the off-axis cut silicon wafer.

11. The method according to claim 1, wherein the plurality of structures or devices comprise a plurality of MEMS devices.

12. The method according to claim 1, wherein the plurality of structures or devices comprise a plurality of MEMS mirrors, and wherein the cut angle (α) of the off-axis cut silicon wafer is greater than maximum tilt angle (β) of the respective MEMS mirror.

13. A MEMS mirror manufactured using the method according to claim 1.

14. A pair of augmented reality (AR) glasses, a pair of virtual reality (VR) glasses or a heads-up display comprising at least one MEMS mirror according to claim 12.

15. A method of manufacturing a plurality of devices having an optical glass cover comprising an angled optical window, the method comprises:
patterning a face of an off-axis cut silicon wafer to determine a plurality of unmasked areas of the off-axis cut silicon wafer;
wet-etching the plurality of unmasked areas to reveal a plurality of Si surfaces of the off-axis cut silicon wafer, to form a silicon mold comprising a plurality of angled recesses, wherein an angled shape of each angled recess is determined by a respective Si surface;
molding heat-softened borosilicate glass using the silicon mold to form a plurality of angled glass portions;
cooling the molded borosilicate glass;
polishing the cooled borosilicate glass;′
anodically bonding the polished borosilicate glass to a silicon device wafer comprising a plurality of structures or circuitry for the plurality of devices; and
dicing a wafer stack to separate the plurality of devices having the optical glass cover, wherein the optical glass cover of each device comprises the respective angled optical window determined by one of the angled recesses of the silicon mold,
wherein thickness of a layer of borosilicate glass is between 50 μm and 500 μm, and
wherein the thickness of the layer of borosilicate glass is more than a greatest vertical distance from non-etched portions of the patterned face of the silicon mold to a bottom of the recess formed by the angled portion of the silicon mold.

16. The method according to claim 15, wherein the molding of the borosilicate glass using the silicon mold further comprises:
applying the layer of borosilicate glass on the silicon mold in vacuum to hermetically seal the plurality of angled recesses in the silicon mold, and
a) heating up the layer of borosilicate glass, and applying an inert pressure to cause the heated layer of borosilicate glass to adapt to the shape of the silicon mold, or
b) heating up the layer of borosilicate glass into a temperature above its Littleton Softening Point and allowing a heated sheet of borosilicate glass to adapt to the shape of the silicon mold under its own weight.

17. The method according to claim 16, wherein a thickness of the layer of borosilicate glass is less than a greatest vertical distance from non-etched portions of the patterned face of the silicon mold to a bottom of the recess formed by the angled portion of the silicon mold.

18. The method according to claim 15, wherein molding the borosilicate glass using the silicon mold comprises:
molding a layer of heat-softened borosilicate glass on the silicon mold; and
grinding the molded layer of borosilicate glass after cooling and before polishing.

19. A method of manufacturing a plurality of devices having an optical glass cover comprising an angled optical window, the method comprises:
patterning a face of an off-axis cut silicon wafer to determine a plurality of unmasked areas of the off-axis cut silicon wafer;
wet-etching the plurality of unmasked areas to reveal a plurality of Si surfaces of the off-axis cut silicon wafer to form a silicon mold comprising a plurality of angled recesses, wherein an angled shape of each angled recess is determined by a respective Si surface;
molding a heat-softened borosilicate glass using the silicon mold to form a plurality of angled glass portions;
cooling the molded borosilicate glass;
polishing the cooled borosilicate glass;
anodically bonding the polished borosilicate glass to a silicon device wafer comprising a plurality of structures or circuitry for the plurality of devices; and
removing the silicon mold by etching to release a wafer stack with the borosilicate glass and the silicon device; and
dicing a wafer stack to separate the plurality of devices having the optical glass cover, wherein the optical glass cover of each device comprises the respective angled optical window determined by one of the angled recesses of the silicon mold;
wherein molding borosilicate glass using the silicon mold further comprises:
molding a layer of heat-softened borosilicate glass on the silicon mold, and
grinding the molded layer of borosilicate glass after cooling and before polishing, and
wherein thickness of the layer of borosilicate glass is between 200 μm and 1000 μm.

20. The method according to claim 19, wherein cooling of the molded borosilicate glass is performed using a controlled temperature ramp to ensure high quality of the borosilicate glass.
